(19) United States
(12) Patent Application Publication
(10) Pub. No.: US 2014/0163937 A1
(43) Pub. Date: Jun. 12, 2014

(54) METHOD FOR PREDICTING PHYSICAL PROPERTIES OF A COMPOSITE BLEND OF POLYPROPYLENE AND LOW DENSITY POLYPROPYLENE

(71) Applicant: HYUNDAI MOTOR COMPANY, Seoul (KR)

(72) Inventor: Keum Hyang Lee, Seoul (KR)

(73) Assignee: HYUNDAI MOTOR COMPANY, Seoul (KR)

(21) Appl. No.: 13/855,207

(22) Filed: Apr. 2, 2013

(30) Foreign Application Priority Data
Dec. 12, 2012 (KR) 10-2012-0144759

(51) Int. Cl. G06F 19/00

(52) U.S. Cl. CPC G06F 19/704
USPC 703/2

(57) ABSTRACT

Disclosed is a method for predicting mechanical and physical properties, particularly tensile strength and flexural strength, of a composite blend of polypropylene and low density polyethylene. More particularly, the present invention provides an easy and efficient analysis technique for predicting mechanical and physical properties through the calculation of a composition ratio of each component. Such a technique can be effectively used for investigating the cause of quality problems of automobile parts, improving the quality of automobile parts by preventing the occurrence of quality problems, and benchmarking.

### CROSS-REFERENCE TO RELATED APPLICATION

This application claims under 35 U.S.C. §119 (a) the benefit of Korean Patent Application No. 10-2012-0144759 filed Dec. 12, 2012, the entire contents of which are incorporated herein by reference.

### BACKGROUND

(a) Technical Field

The present disclosure relates to a method for predicting the change in physical properties, such as tensile strength and flexural strength, of a composite blend. More particularly, the present invention provides a method for predicting the change in physical properties of a composite blend of polypropylene and low density polyethylene depending on the composition ratio after an exact analysis of a blending ratio between the components.

(b) Background Art

In blends of polypropylene and low density polyethylene, polypropylene and low density polyethylene have similar chemical structures, and thus it is difficult to analyze their blending composition ratio. Such a composite blend exhibits a single type of physical properties, and these physical properties are representative values similar to those of a single component based material. This makes the blending ratio between components an important factor because variations in the blending ratio result in changes in physical properties of the blend. However, in case of a door trim or a console floor, which are among various interior parts currently being used in most vehicles, it is difficult to obtain a sample thereof to assess physical properties because they are on-vehicle parts. As such, there is a need to develop a method for predicting physical properties of a part based on analysis results thereof.

Polypropylene is represented by following Chemical Formula 1, and low density polyethylene is represented by following Chemical Formula 2.

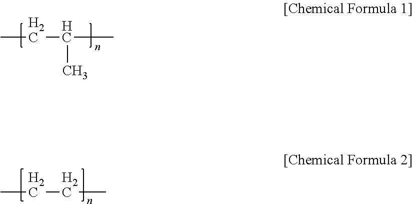

Table 1 shows the change in general mechanical and physical properties of a composite blend of polypropylene and low density polyethylene as a result of an increase in polypropylene content.

TABLE 1

| | Tensile | Flexural | Impact | | |
|---|---|---|---|---|---|
| | strength | strength | strength | Shrinkage | Formability |
| Change in | Increase | Slight | Slight | Increase | Decrease |
| physical | | increase | decrease | | |
| properties | | | | | |

While there are techniques for analyzing physical properties of a polymer using an analyzer, such as NMR, these techniques are inadequate.

Japanese Patent Application Publication No. H05-0086119 describes a polyethylene composition which is characterized in that a melt flow rate (MFR) is 0.1 g/10 min or below. As set out, data obtained by a CPMG spin echo method of ¹H NMR analysis at 190° C. is interpreted according to a formula.

Korean Patent Application Publication No. 2002-0026554 describes an elastomeric polymer comprising a hydrogenated block polymer and another polymer, such as an ethylene/vinyl aromatic interpolymer, a styrene/conjugated diene interpolymer and an elastomeric metallocene-catalyzed synthetic polymer or blends thereof. As set out, the hydrogenation of the block polymer is measured by using UV-VIS spectroscopy and ¹H NMR.

Japanese Patent No. 3,367,585 describes a polyethylene resin composition comprising a homopolymer of propylene or olefin at a constant level by measuring a peak area, a melting point (Tm), and a melt enthalpy in the range of 22.5-19.5 ppm by ¹³C NMR.

Korean Patent Application Publication No. 2002-0034427 describes a polypropylene composition comprising highly crystalline polypropylene, low molecular polypropylene or polyethylene, wherein the highly crystalline polypropylene has a pentad fraction of 97% or higher measured by 13C NMR.

U.S. Pat. No. 6,144,897 describes a control method for applying a process to the synthesis of a chemical by predicting controlled variables with a predictor and assessing physical properties of a polymer by NMR.

However, none of the above mentioned documents teach or even suggest a technique for qualifying single component-based physical properties of a composite blend of polypropylene and low density polyethylene, wherein the components possess a similar chemical structure which results in bicomponent-based physical properties.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art. In particular, an object of the present invention is to develop a modeling formula for calculating an exact blending ratio of polypropylene and low density polyethylene in a composite blend, and predicting physical properties such as tensile strength and flexural strength based on the calculated blending ratio.

In one aspect, the present invention provides a simple and reliable modeling formula for calculating an exact composition ratio of polypropylene and low density polyethylene in a composite blend. Using the thus calculated composition ratio, mechanical and physical properties of the blend, such as tensile strength and flexural strength, can be predicted.

In another aspect, the present invention provides a simple and reliable testing method for analyzing an exact composition ratio of polypropylene and low density polyethylene in a composite blend in one step, and predicting changes in physical properties of the composite blend depending upon changes in the composition ratio.

In order to achieve the above aspect, the present inventors have experimentally confirmed that the change in mechanical and physical properties of a composite blend of polypropylene and low density polyethylene is correlated with a blending ratio of polypropylene and low density polyethylene. The present invention provides a method that has been developed for measuring several standard samples having different blending ratios based on the experimentally determined correlation, and predicting mechanical and physical properties (e.g. tensile strength and flexural strength) as depending upon the correlation and measured values.

In a preferred embodiment, the present invention provides a method for predicting tensile strength of an unknown sample composite blend of polypropylene and low density polyethylene based upon a blending ratio of polypropylene in the unknown sample. Then, Prediction Formula 1 is used to calculate tensile strength of the composite blend from a blending ratio of polypropylene in the unknown sample, followed by a calculation of flexural strength using Prediction Formula 2.

0.1884(PP,%)+10.132 Prediction Formula 1

0.4455(PP,%)+8.5764: Prediction Formula 2

In another preferred embodiment, the present invention provides a method for calculating a blending ratio of polypropylene in the unknown sample by using an NMR spectrometer through the following Conversion Formulae \textcircled{1} to \textcircled{7}.
\textcircled{1} area of polypropylene (1.75 ppm)=APP
\textcircled{2} area of low density polyethylene (1.38 ppm)=ALDPE
\textcircled{3} area ratio (ARatio)=APP:ALDPE=100:165.13
\textcircled{4} polyepropylene monomer molecular weight (MPP)=42.07 g/mol
\textcircled{5} low density polyethylene monomer molecular weight (MLDPE)=28.05 g/mol
\textcircled{6} polyproylene content ratio=MPP/MPP+(MPP+ARatio)*100%
\textcircled{7} low density polyethylene content ratio=MLDPE*ARatio/MPP+(MPP+ARatio)*100%

Other aspects and exemplary embodiments of the invention are discussed infra.

### Effect of the Invention

The present invention relates to a method for predicting mechanical and physical properties of a composite blend of polypropylene and low density polyethylene. Such a composite blend has been widely used as interior parts of automobile such as a door trim and a console floor.

Polypropylenes are thermoplastic resin materials made by polymerizing propylene. Because of their excellent mechanical and physical properties, high formability and moderate prices, they have been widely used in various fields such as in the vehicle industry and in forming general merchandise and the like. Low density polyethylenes are made by ethylene polymerization. During the polymerization, since branched C6˜C8 hydrocarbons are introduced into an ethylene chain, they exhibit improved impact resistance. As such, low density polyethylenes have been widely used as materials for general merchandise. Together, polypropylene and low density polyethylene materials compensate for the advantages and disadvantages of the other material, such that a composition ratio between the materials can be adjusted so as to satisfy the requirements for physical properties in vehicle parts. Therefore, the present invention provides a simple and reliable testing method capable of predicting mechanical and physical properties through a progressive analysis of polypropylene and low density polyethylene in the composite blend.

The prediction method of the present invention can predict mechanical and physical properties of the composite blend with high accuracy and reproducibility through a simple analysis of a blending ratio. Therefore, the prediction method of the present invention can be effectively used for investigating the cause of quality problems of automobile parts, improving the quality of automobile parts by preventing the occurrence of quality problems, and benchmarking.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 illustrates the NMR spectrum of a composite blend of polypropylene and low density polyethylene used in the Examples, in which peaks caused by the difference in a chemical structure between polypropylene and polyethylene are observed in the range of 1.35˜1.50 ppm.

FIG. 2 illustrates a modeling formula calculation graph for predicting tensile strength of a composite blend of polypropylene and low density polyethylene used in the Examples.

FIG. 3 illustrates a modeling formula calculation graph for predicting a regression analysis of a flexural strength change in a composite blend of polypropylene and low density polyethylene used in the Examples.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The present invention provides a method for predicting tensile strength of an unknown sample of a composite blend of polypropylene and low density polyethylene based on a blending ratio of polypropylene in the unknown sample. Further, the following Prediction Formula 1, or flexural strength of an unknown sample of a composite blend of polypropylene and low density polyethylene, is used by inserting the blending ratio of polypropylene in the unknown sample, followed by calculation using Prediction Formula 2.

0.1884(PP,%)+10.132 Prediction Formula 1

0.4455(PP,%)+8.5764: Prediction Formula 2

Further, the prediction method of the present invention is characterized in that the composition ratio of polyethylene in the unknown sample is calculated by using a NMR spectrometer according to the following Calculation Formulae \textcircled{1} to \textcircled{7}.
\textcircled{1} area of polypropylene (1.75 ppm)=APP
\textcircled{2} area of low density polyethylene (1.38 ppm)=ALDPE
\textcircled{3} area ratio (ARatio)=APP:ALDPE=100:165.13
\textcircled{4} polyepropylene monomer molecular weight (MPP)=42.07 g/mol
\textcircled{5} low density polyethylene monomer molecular weight (MLDPE)=28.05 g/mol
\textcircled{6} polyproylene content ratio=MPP/MPP+(MPP+ARatio)*100%
\textcircled{7} low density polyethylene content ratio=MLDPE*ARatio/MPP+(MPP+ARatio)*100%

The prediction method of the present invention can determine mechanical and physical properties depending on the content of polypropylene in the composite blend of polypropylene and low density polyethylene. Further, the present invention can be used to design a material having particular physical and mechanical properties based thereon. To date, no such method for exactly predicting the variation of mechanical and physical properties according to the blending ratio exists. Thus, the present invention provides, for the first time, such a prediction method, which provides a useful modeling formula having a reliability of about 97% or higher.

According to the present invention, a variety of composite blends of polypropylene and low density polyethylene were prepared having different blending composition ratios. The exact composition ratio of these blends was calculated by using an NMR spectrometer. Then, it was confirmed that tensile strength and flexural strength are increased in proportion to the content of polypropylene.

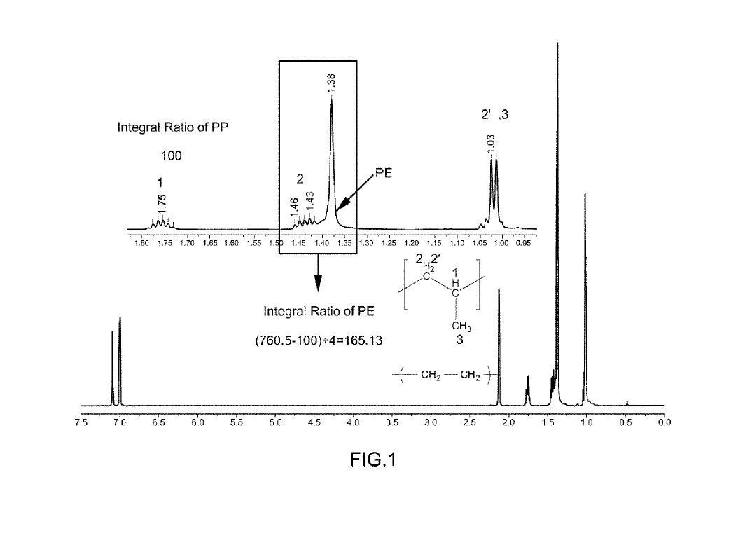

In particular, the chemical structure analysis of a test sample with an NMR spectrometer shows that in the spectrum in which the compositions have a similar chemical structure, but there is a difference in chemical structure between polypropylene and polyethylene in a range of 1.35˜1.50 ppm, the integral value corresponding to polypropylene is subtracted from the whole integral value, and the molecular weight of each monomer is converted therefrom. Based thereon, it is possible to exactly calculate the blending ratio of each monomer (wt %) (see FIG. 1).

[Calculation Formula] Step of Calculating a Blending Composition Ratio

1. Area ratio of a standard sample (polypropylene and polyethylene 50:50 wt %) in a spectrum
\textcircled{1} area of polypropylene (1.75 ppm)=APP
\textcircled{2} area of low density polyethylene (1.38 ppm)=ALDPE
\textcircled{3} area ratio (ARatio)=APP:ALDPE=100:165.13

2. Conversion into wt % by using a molecular weight of a monomer
\textcircled{4} molecular weight of polypropylene monomer (MPP)=42.07 g/mol
\textcircled{5} molecular weight of low density polyethylene monomer (MLDPE)=28.05 g/mol

3. Calculation of a blending ratio after the analysis of an unknown sample
\textcircled{6} content ratio of polypropylene=MPP/MPP+(MPP+ARatio)*100%
\textcircled{7} content ratio of low density polyethylene=MLDPE*ARatio/MPP+(MPP+ARatio)

As such, it is possible to exactly calculate the blending composition ratio of each monomer in an unknown sample by using the above Calculation Formulae. Here, it is noted that the blending composition ratio is calculated by regarding the area ratio of polypropylene at 1.75 ppm in the spectrum as 100, subtracting the area ratio measured at the range of 1.35 ppm to 1.50 ppm therefrom, and dividing it by a number of hydrogen, which is 4. In order to ensure reliability on the analysis results of a blending composition ratio as described above, the analysis results depending on a variety of blending composition ratios are shown as follows. As a result, using the present method, it is possible to ensure the analysis results with significantly high accuracy and reproducibility of about 97% or even about 98% or higher. Table 2 shows the analysis conditions used in the Examples of the present invention.

TABLE 2

| | Analysis conditions |
|---|---|
| Solvent | Toluene - d₈ |
| Analysis temperature | 110 |

Table 3 shows the data comparing the analysis results of Examples 1 to 3 according to actual blending composition ratios of polypropylene and low density polyethylene.

TABLE 3

| | PP | LDPE | PP | LDPE | PP | LDPE |
|---|---|---|---|---|---|---|
| Blending ratio | 50 | 50 | 70 | 30 | 90 | 10 |
| Example 1 | 49.45 | 50.55 | 70.13 | 29.87 | 90.70 | 9.30 |
| | 49.33 | 50.67 | 70.27 | 29.73 | 90.35 | 9.65 |
| | 49.47 | 50.53 | 70.09 | 29.91 | 90.21 | 9.79 |
| Example 2 | 49.28 | 50.72 | 70.34 | 29.66 | 89.06 | 10.94 |
| | 49.15 | 50.85 | 70.52 | 29.48 | 89.02 | 10.98 |
| | 49.04 | 50.96 | 70.20 | 29.80 | 89.04 | 10.96 |
| Example 3 | 49.72 | 50.28 | 70.17 | 29.83 | 88.60 | 11.40 |
| | 49.51 | 50.49 | 70.13 | 29.87 | 88.73 | 11.27 |
| | 49.52 | 50.48 | 70.23 | 29.77 | 88.71 | 11.29 |
| Average | 49.42 | 50.58 | 70.16 | 29.84 | 90.42 | 9.58 |
| Standard deviation | 0.08 | 0.08 | 0.10 | 0.10 | 0.26 | 0.26 |

The step of assessing mechanical and physical properties depending on the blending ratio by using a universal testing machine was carried out according to a standard test method of ASTM D638 which uses a Type 1 test sample, and which was tested at a tensile rate of 50 mm/min. The flexural strength was measured according to a standard test method of ASTM D790 which uses a test sample having a size of 127×12.7×6.4 mm, and which was tested at a flexural rate of 30 mm/min. Table 4 shows the results of assessing mechanical and physical properties depending different blending ratios.

TABLE 4

| | Tensile strength | Flexural strength |
|---|---|---|
| | (MPa) | (MPa) |
| PP:LDPE = 100:0 | 30 | 55 |
| PP:LDPE = 90:10 | 27 | 48 |
| PP:LDPE = 70:30 | 23 | 40 |
| PP:LDPE = 50:50 | 18 | 28 |
| PP:LDPE = 0:100 | 12 | 10 |

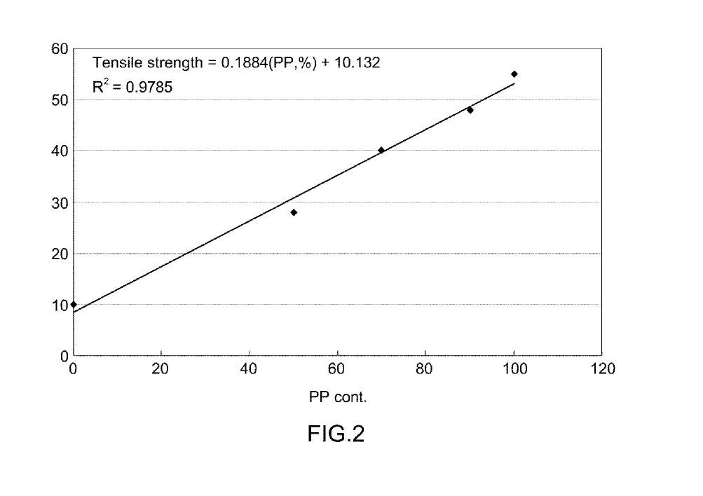

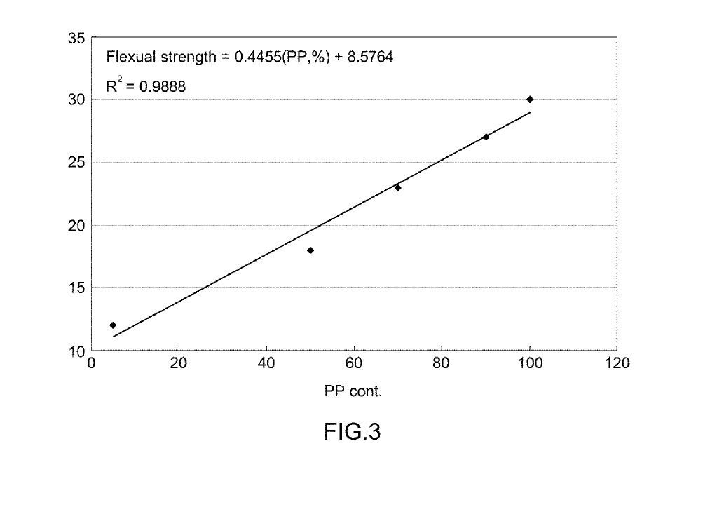

The step of developing a modeling formula for predicting tensile strength and flexural strength depending on the blending ratio is based on the results of mechanical and physical properties assessed above. That is, when the numerical values of physical properties assessed according to the blending composition ratio are subjected to a regression analysis so as to calculate a modeling formula, it is possible to obtain the results having a reliability of about 97% or higher. Such a regression analysis is calculated as a linear function. Since the linear function represents the change in physical properties in proportion to the composition ratio, its reliability is significantly increased. Also, its applicability becomes higher by predicting physical properties depending on a wide range of the blending composition ratio. FIG. 2 represents the regression analysis on the change in tensile strength depending on the content of polypropylene in the composite blend of polypropylene and low density polyethylene and the calculation of a modeling formula therefrom. FIG. 3 represents the regression analysis on the change in flexural strength depending on the content of polypropylene in the composite blend of polypropylene and low density polyethylene and the calculation of a modeling formula therefrom.

Both the modeling formulae of tensile strength and flexural strength, which are representative mechanical and physical properties of a polymer material, can thus be predicted depending on the composition ratio with very satisfying results with about 97% or higher of linearity. As such, the present invention is capable of predicting physical properties with high reliability based on exact analysis results, and thus is effective for used in a variety of industrial fields.

In sum, the present invention relates to a method for predicting mechanical and physical properties of a composite blend of polypropylene and low density polyethylene. Such composite blends are widely used in the fabrication of inner parts of automobile, such as a door trim and console floor. The method of the present invention provides for highly accurate and reliable prediction of mechanical and physical properties through a simple analysis of a composition ratio. The prediction method of the present invention is suitable for use in investigating the cause of quality problems of automobile parts, improving the quality of automobile parts by preventing the occurrence of quality problems, and benchmarking.

### EXAMPLES

The following examples illustrate the invention and are not intended to limit the same.

### Example

### Center Pillar Lower Trim Part (LG Chem LUPOL EI 5002)

In order to examine industrial applicability of the inventive modeling formula for predicting physical properties, it was applied to a center pillar lower trim of a vehicle. This part was made of a LG Chem LUPOL EI 5002 material, and its content ratio of polyethylene and low density polyethylene was 80 wt % and 20 wt %. In addition, the part satisfied the requirements for a material standard in which tensile strength is 25 MPa or higher and flexural strength is 29.4 MPa or higher. In order to examine the performance of the inventive method, the blending composition ratio of polyethylene and low density polyethylene was analyzed by using Calculation Formula 1 according to the inventive method (Table 5).

TABLE 5

| | Analysis result |
|---|---|
| polypropylene:low density polyethylene | 78 wt %:22 wt % |

After the exact blending composition ratio was confirmed, a regression analysis was performed as described in FIGS. 2 and 3. In particular, the blending composition ratio was substituted for the modeling formula for predicting mechanical and physical properties as follows, to thereby numerically predict tensile strength and flexural strength. It was demonstrated that when the measuring value was regarded as a real value, the modeling formula of the present invention shows an excellent reliability of about 95% or higher.

The results of predicting the tensile strength and flexural strength of said material according to the method of the present invention are shown in Table 6.

TABLE 6

| Tensile strength | | | Flexural strength | | |
|---|---|---|---|---|---|
| Predicting | Measuring | Error | Predicting | Measuring | Error |
| value (MPa) | value (MPa) | (%) | value (MPa) | value (MPa) | (%) |
| 24.83 | 26.11 | 4.9 | 43.33 | 44.96 | 3.6 |

As a result, it was confirmed that the prediction method of the present invention exhibits excellent reliability and reproducibility. In addition, it was found that since it is possible to predict physical property values exactly only with a single analysis, the prediction method of the present invention can be effectively and conveniently used in the industrial field. Further, the prediction method of the present invention can be applied for the investigation of a cause for quality problem such as breakdown of a part and efficient material management.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for predicting tensile strength of an unknown composite blend sample of polypropylene and low density polyethylene comprising:
determining a blending ratio of polypropylene in the composite blend, and using the following Prediction Formula 1 to determine flexural strength of the composite blend based on the determined blending ratio of polypropylene in the composite blend, and then following Prediction Formula 2.
0.1884(PP,%)+10.132 Prediction Formula 1
0.4455(PP,%)+8.5764: Prediction Formula 2

2. The method according to claim 1, wherein the blending ratio of polyethylene in the composite blend is determined from the following Calculation Formulae \textcircled{1} to \textcircled{7} by using an NMR spectrometer:
\textcircled{1} area of polypropylene (1.75 ppm)=APP
\textcircled{2} area of low density polyethylene (1.38 ppm)=ALDPE
\textcircled{3} area ratio (ARatio)=APP:ALDPE=100:165.13
\textcircled{4} molecular weight of polypropylene monomer (MPP)=42.07 g/mol
\textcircled{5} polypropylene monomer of low density polyethylene monomer (MLDPE)=28.05 g/mol
\textcircled{6} content ratio of polypropylene=MPP/MPP+(MPP+ARatio)*100%
\textcircled{7} content ratio of low density polyethylene=MLDPE*ARatio/MPP+(MPP+ARatio)*100%

3. The method according to claim 1, wherein the Prediction Formulae 1 and 2 are obtained by measuring tensile strength and flexural strength of the composite blend by using an universal testing machine and regressively analyzing linear functions of tensile strength and flexural strength depending on an increase in polypropylene content.
